(19) United States
(12) Patent Application Publication
(10) Pub. No.: US 2016/0137314 A1
(43) Pub. Date: May 19, 2016

(54) CONSTRUCTION METHOD FOR A LEVER KINEMATICS AND USES THEREOF

(71) Applicant: Airbus Defence and Space GmbH, Ottobrunn (DE)

(72) Inventor: Stefan Storm, Unterschleissheim (DE)

(21) Appl. No.: 14/931,266

(22) Filed: Nov. 3, 2015

(30) Foreign Application Priority Data
Nov. 14, 2014 (EP) 14 193 280.6

(51) Int. Cl. B64F 5/00

(52) U.S. Cl. CPC B64F 5/0009

(57) ABSTRACT

To simplify the construction of lever kinematics under difficult installation and boundary conditions, a construction method for constructing a lever kinematics comprises a main lever and at least one connecting strut. The main lever can be rotated about a main lever axis by a predetermined angle, and the connecting strut connects a force application point to a hinge point on the main lever. A first position of the force application point is predetermined at the beginning of the rotational angle and a second position of the force application point is predetermined at the end of the rotational angle. The method includes representing a line of the possible hinge points for the given rotational angle, the main axis and the first and second positions of the force application point, and selecting the hinge point on the line.

This invention relates to a construction method for constructing a lever kinematics with the features of the generic part of claim 1, and to uses of the method.

A correspondingly constructed lever kinematics is disclosed for example in EP 0 130 983 B1 or in U.S. Pat. No. 4,427,168.

For the structural deformation of flexible skin structures such as for gap-free high-lift configurations on wing leading edges of airplanes or similar aircrafts, accurately fixed paths have to be traced at distributed force application points. To reduce the complexity of the entire system, the actuating elements should be coupled in an effective manner. It is desired that individual kinematic subsystems (one force application point is included per kinematic system) be operated with only one central drive unit such as a rotary drive unit for example. The problem in the construction of such structures and their units is to define suitable kinematic nodes for an axis of rotation of the main lever and for connection points of the connecting struts which correspond to the rigidity specifications and mass specifications within a limited available space.

One possible approach for the construction could be setting up the kinematic problem numerically and solving it by an optimization process. However, as an influence on the solution finding, e.g. through additional boundary conditions, is possible to a limited extent only and as an unsuitable result does not allow to give information about the cause—such as wrong or unsolvable boundary conditions—the numerical approach cannot be used for challenging problems or can be used at best for high-precision optimization.

It is an object of the invention to provide a construction method for the construction of a lever kinematics with which even complicated lever mechanisms can be relatively easily constructed also under difficult boundary conditions.

For the solution of this object, there are provided the construction method according to claim 1, the use of the lever mechanism construction method according to claim 6, and uses of the construction method according to claim 7. A production method involving the use of such a construction method as well as a computer program product with computer program codes with which the construction method can be implemented on a computer, are the subject of additional claims.

Advantageous embodiments of the invention are the subject of the subclaims.

The invention provides a construction method for constructing a lever kinematics comprising a main lever and at least one connecting strut, wherein the main lever can be rotated about a main lever axis by a predetermined angle and the connecting strut connects a force application point to a hinge node on the main lever and wherein a first position of the force application point is predetermined at the beginning of the rotational angle and a second position of the force application point is predetermined at the end of the rotational angle, the method being characterized by the step:
a) representing a line of the possible hinge points for the given rotational angle, the main axis and the first and second positions of the force application point as a selection guide for selecting the hinge point.

The line, in the following also referred to as isogonic line, represents the loci of possible hinge points and thus can serve the design engineer to immediately find possible solutions based on a representation. Ideal hinge points are indicated on the line. For solutions, which are not ideal but still workable, hinge points may possibly be selected also in the proximity of the line.

For the ideal solution, the construction method preferably comprises the additional step:
b) selecting the hinge point on the line.

A preferred construction method is characterized by geometrically representing the main lever at the beginning and at the end of the rotational angle and of the first and the second point of application.

Step a) preferably includes:

representing the line for the beginning of the rotational angle and representing the line for the end of the rotational angle.

Step a) preferably includes:

geometrically constructing the line in the form of a straight line on the basis of
parallelism conditions
symmetry conditions
collinearity conditions
perpendicularity conditions

Step b) preferably includes:

selecting the hinge node on the basis of boundary conditions and/or the available space for the lever kinematics.

It is preferred that the selection of the hinge node be made on the basis of boundary conditions at both endpoints of the rotational angle.

To keep the forces acting in the lever kinematics and in the supporting structure small and thus to achieve a lower weight of the entire lever kinematics, preferably large rotational angles of the main lever are chosen—which allows to obtain a high reduction ratio—if the available space permits.

The position of the axis of rotation is preferably chosen in dependence of the selection of the drive unit and/or the supporting structure. For example, at direct coupling with a rotary drive unit, the region of the axis of rotation of the main lever is predetermined by the dimensions of the drive unit, if the drive unit has to be located inside the available space.

The effective direction of the force on the connecting strut is preferably selected in dependence of the arrangement of the lever kinematics relative to the skin structure and the action of force on the skin structure.

In a preferred approach, a change of sign of the force vector along the connecting strut is avoided so that a possible bearing play will not lead to undesired impact loads. This can be influenced by the selection of the hinge point for the connecting strut.

When a lever kinematics is constructed for driving a deformation of a flexible skin structure, a selection is preferably made with view to a uniform movement of all points of force. For driving flexible skin structures, the uniform movement of all force application points is a criterion for the selection of node or hinge points which should be given priority. Should a single force application point be leading or trailing, this would instantly lead to bulging or to a change of flow in a flexible skin structure.

The procedure for designing a lever kinematics unit preferably takes place in the order of: 1) selecting the drive unit, 2) selecting the axis of rotation, 3) selecting the angle of rotation, 4) selecting the hinge point on the start or finish isogonic line. If a suitable hinge point cannot be found, it should be first examined whether a modified rotational angle will lead to success. Only then the axis of rotation or the drive unit should be changed. Reasons for unsuitable hinge points are for example: not constructible because no longer inside the available space; assembly not possible; lever lengths of the connecting strut or the main lever too short; unsuitable or acute angles (e.g. less than 40°) relative to the skin structure; excessively high forces.

In a further aspect, the invention provides a lever mechanism construction method for the construction of a lever mechanism arrangement with coupled lever kinematics each of which comprising: a main lever and at least one connecting strut such that the main lever can be rotated about a main lever axis by a predetermined angle and that the connecting strut connects a force application point to a hinge point on the main lever and that a first position of the force application point is predetermined at the beginning of the rotational angle and a second position of the force application point is predetermined at the end of the rotational angle, the method comprising: selecting the one of the lever kinematics that has to meet the majority of boundary conditions as the higher-ranking master kinematics, carrying out the construction method in compliance with one of the previously described configurations for the master kinematics and thereafter carrying out the construction method for a further coupled lever kinematics taking under consideration of the construction of the master kinematics as a boundary condition.

Preferably, the construction method is used for the construction of a drive mechanism for the structural deformation of flexible skin structures.

Preferably, the construction method is used for constructing a mechanical drive unit for a high-lift arrangement on a wing leading edge of an aircraft.

Preferably, the construction method is used for the construction of a control mechanism for controlling control surfaces in airplanes, helicopters or other aircrafts.

Preferably, the construction method is used for the construction of a control mechanism for controlling fluid-dynamically effective surfaces in fluid-dynamic bodies.

Preferably, the construction method is used for the construction of a control mechanism for controlling flaps in vehicles and aircrafts.

Preferably, the construction method is used for the construction of running gear kinematics of vehicles and aircrafts.

Preferably, the construction method is used for the construction of hinge systems or movement kinematics of doors, for example doors of vehicles and aircrafts.

A further preferred use is the construction of driving mechanisms with which the windmill blades can change their flow-effective form in order to adjust to the wind conditions. Especially, this can be done in the same manner as with aircraft wings having a flexible skin structure. A deformation can be enabled for example on the leading edge and/or trailing edge of the windmill blade. Such deformations can be easily controlled from central hub of the windmill using lever mechanisms of the kind constructible by the method.

In a further aspect, the invention relates to a production method for producing a lever kinematics comprising a main lever and at least one connecting strut, wherein said main lever can be rotated about a main lever axis by a predetermined angle and wherein said connecting strut connects a force application point to a hinge point on the main lever and wherein a first position of the force application point is predetermined at the beginning of the rotational angle and a second position of the force application point is predetermined at the end of the rotational angle, the production method comprising: performing the construction method in accordance with any one of the preceding configurations and production of the main lever and the connecting strut and coupling the same to each other at the hinge node determined by the construction method.

In a further aspect, the invention relates to a computer program product, characterized in that the same comprises a computer program with computer program code means, said computer program being configured for causing a computer or processor to perform the steps of the method in accordance with one of the above-described configurations.

To simplify the construction of even complicated lever kinematics, the invention proposes to initially represent for a given axis of rotation of the main lever and an associated rotational angle, those geometric curves on which the allowable kinematic points are located. In the following, these curves are also referred to as “isogonic lines”, namely lines corresponding to the same angle. Thereafter, a node is preferably selected on the isogonic line which best solves the kinematic problem. Possibly, even points near the isogonic line may be considered. The farther away from the isogonic line a point is, the less it is suited as a solution.

Geometrical processes offer themselves as a simple method for determining the isogonic line in order to avoid the ambiguous solutions obtained as a result in the analytical approach. Such isogonic lines can be determined not only for kinematic problems in the plane, but also for arbitrary paths or trajectories in the space.

By representing the curves for the possible hinge points—also referred to as isogonic lines—the described kinematic problem can be graphically solved step by step, especially in construction programs.

For example, it can be immediately seen in the representation whether the rotational angle or the axis of rotation common to the overall system have been correctly chosen and which additional boundary conditions are possible.

Possible additional boundary conditions could be for instance a strut orientation quasi-identical to the force direction, a uniform strut length, common kinematic nodes of coupled lever kinematics or the like.

Conclusions can be drawn as to which boundary conditions have to be changed in order to solve the kinematic problem.

A particularly preferred use is the construction of a load-introducing device and a structural component in a manner such as illustrated and described in European patent application 13 196 990.9-1754 (not previously published). Further details are described in this European patent application, the disclosure of which is fully incorporated herein by reference.

Additional conclusions may be drawn as to the position the curve of possible hinge points has to have in order to guarantee a robust kinematic solution with view to given manufacturing tolerances or installation tolerances.

Embodiments of the invention will be described in the following with reference to the drawings, wherein it is shown by:

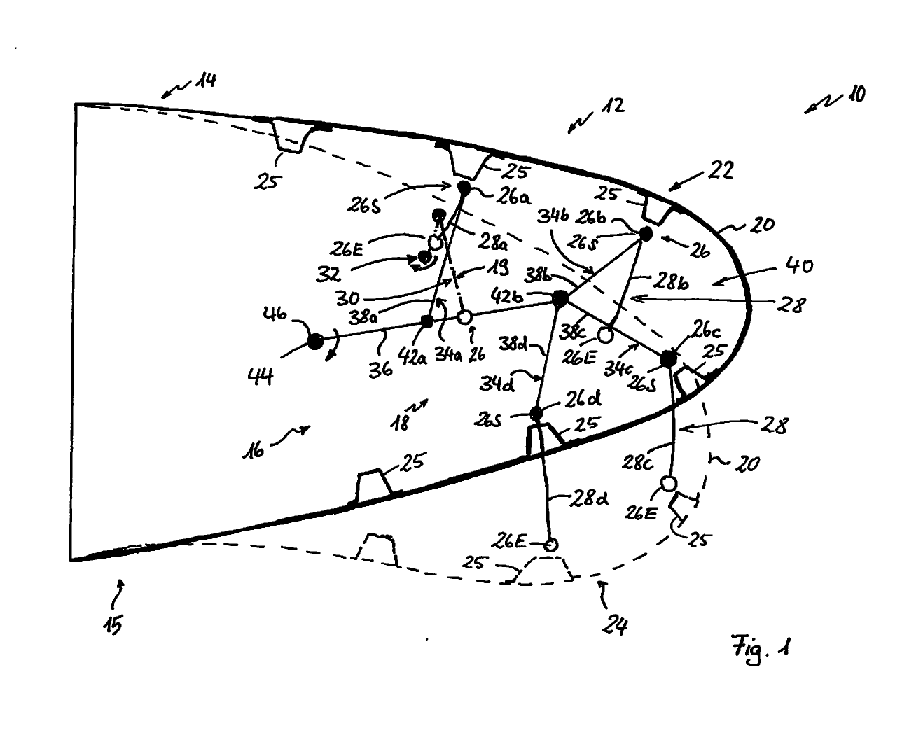

FIG. 1 a span-wise section through a leading edge of a wing with a flexible skin structure (droop nose) with a two-dimensional projection of the initial state and the final state as one example of use of a new construction method for the construction of lever kinematics, wherein there is illustrated a special case of coupled lever kinematics in which several lever kinematics share a common hinge point;

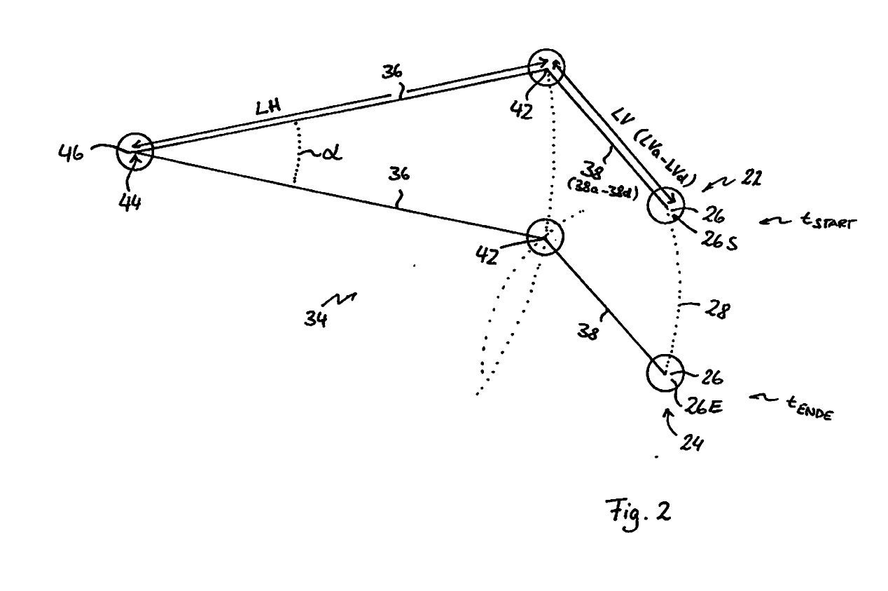

FIG. 2 an individual lever kinematics as a sub-kinematics of the load-introducing device of FIG. 1 that is to be constructed;

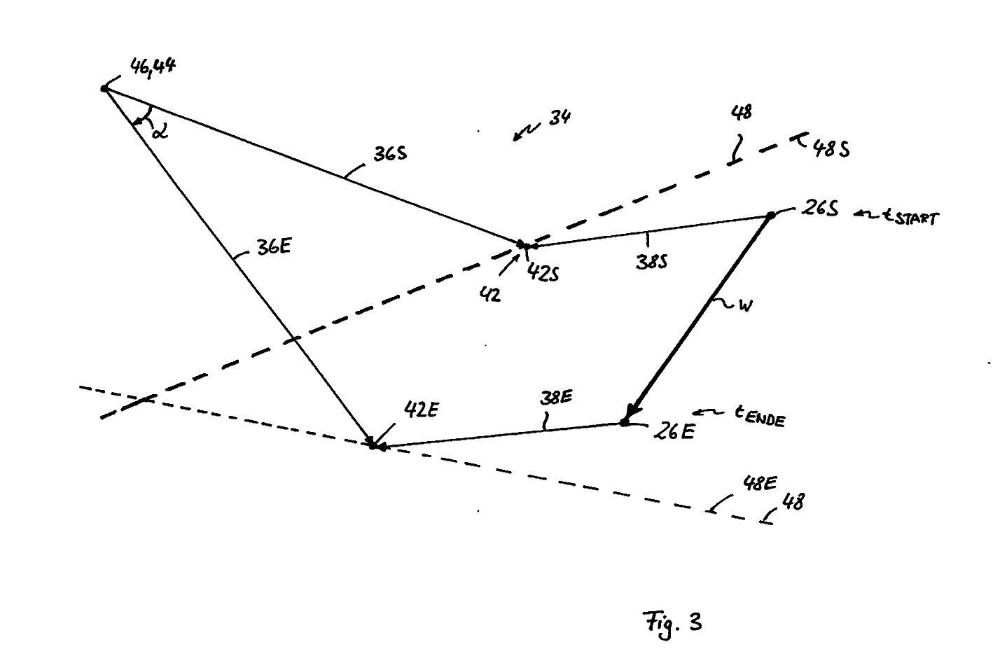

FIG. 3 the schematically represented lever kinematics of FIG. 2 with the rotational angle, the position of the force application point at the beginning of the rotational angle, the position of the force application point at the end of the rotational angle, and the line of the possible hinge points (referred to as isogonic line);

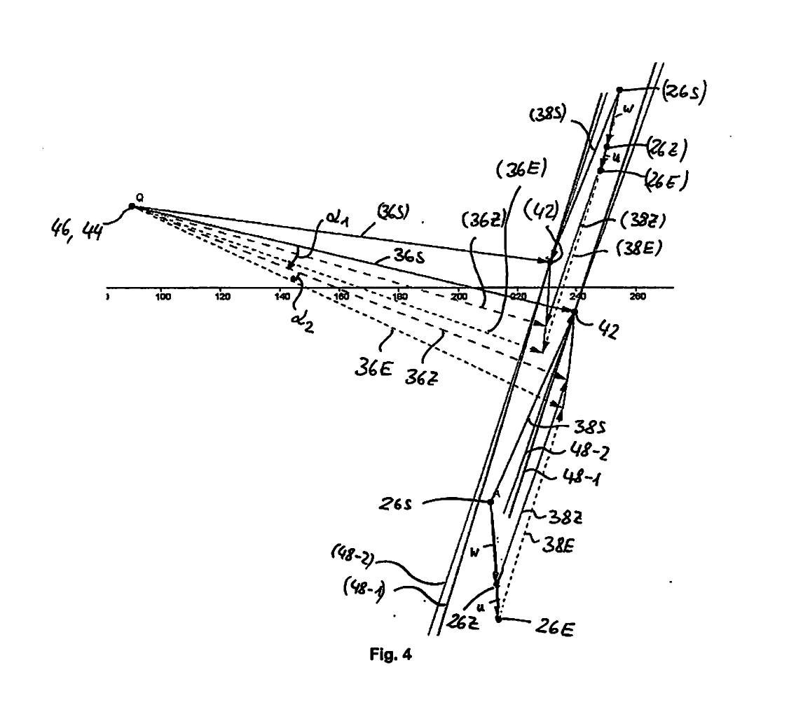

FIG. 4 the graphical representation of the use of the geometrical solution of FIG. 3 for the case of three instead of two force application points;

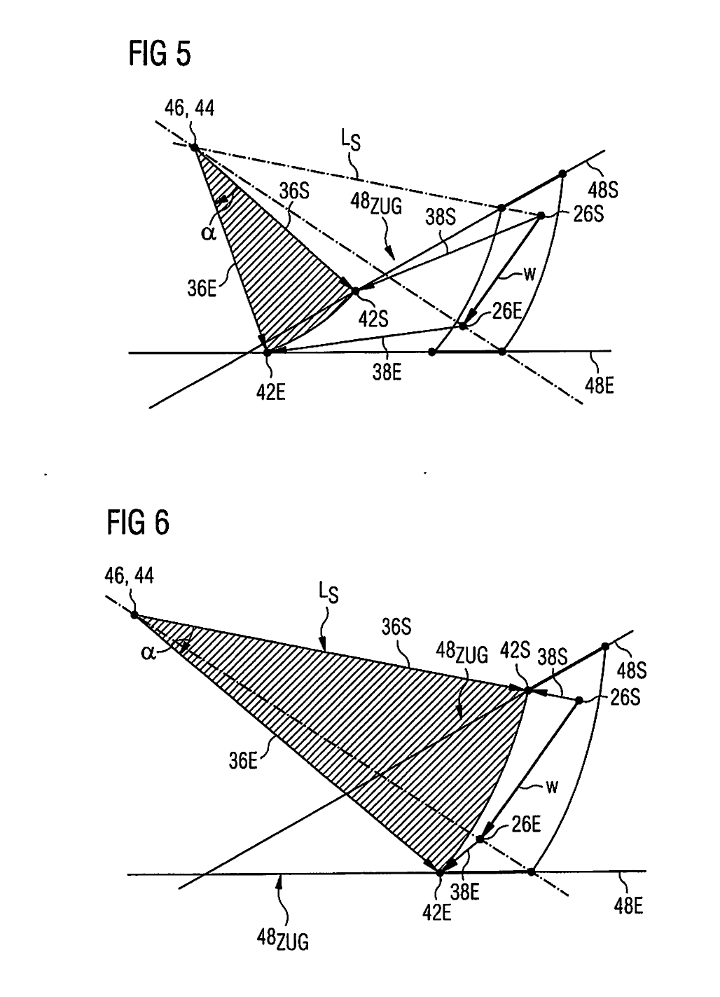

FIGS. 5 and 6 various possible lever kinematics that are suitable for the construction of a tension strut solution according to the graphical solution of FIG. 3;

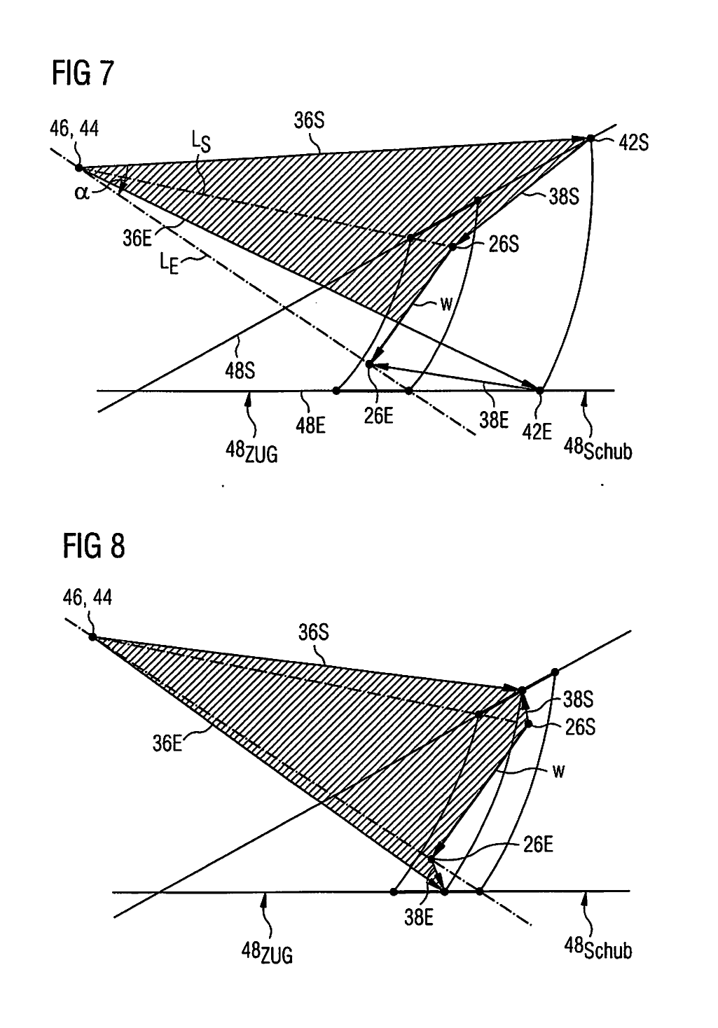

FIG. 7 a possible lever kinematics according to the solution of FIG. 3 including a thrust rod;

FIG. 8 a less favorable lever kinematics;

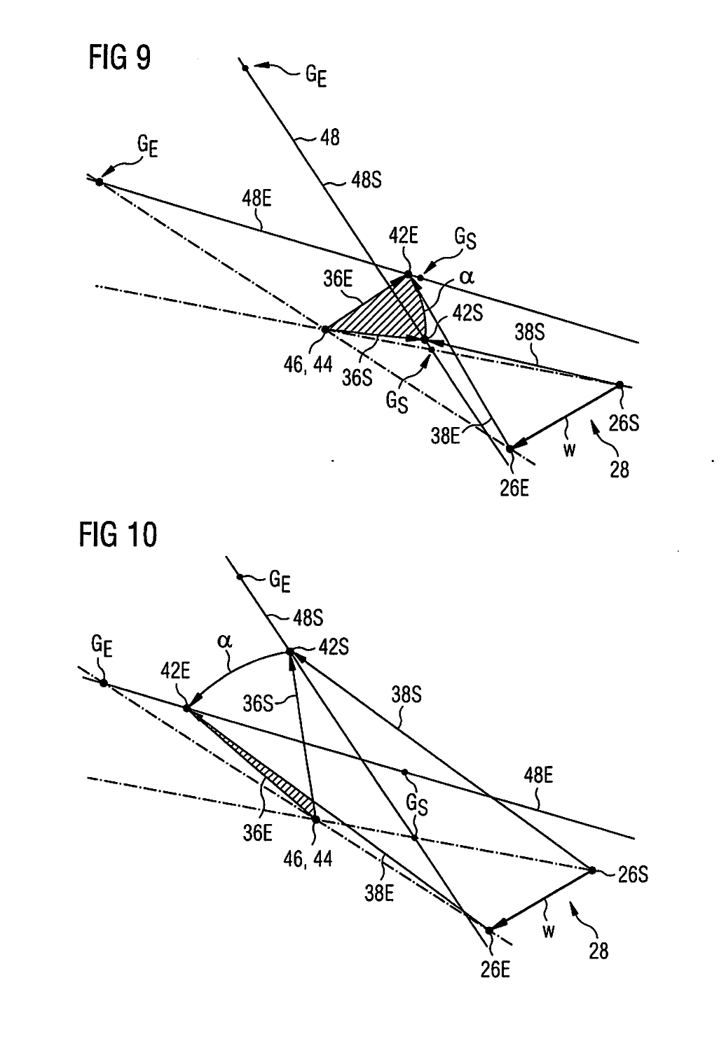

FIGS. 9 and 10 schematic representations of different kinematics for different rotational angles;

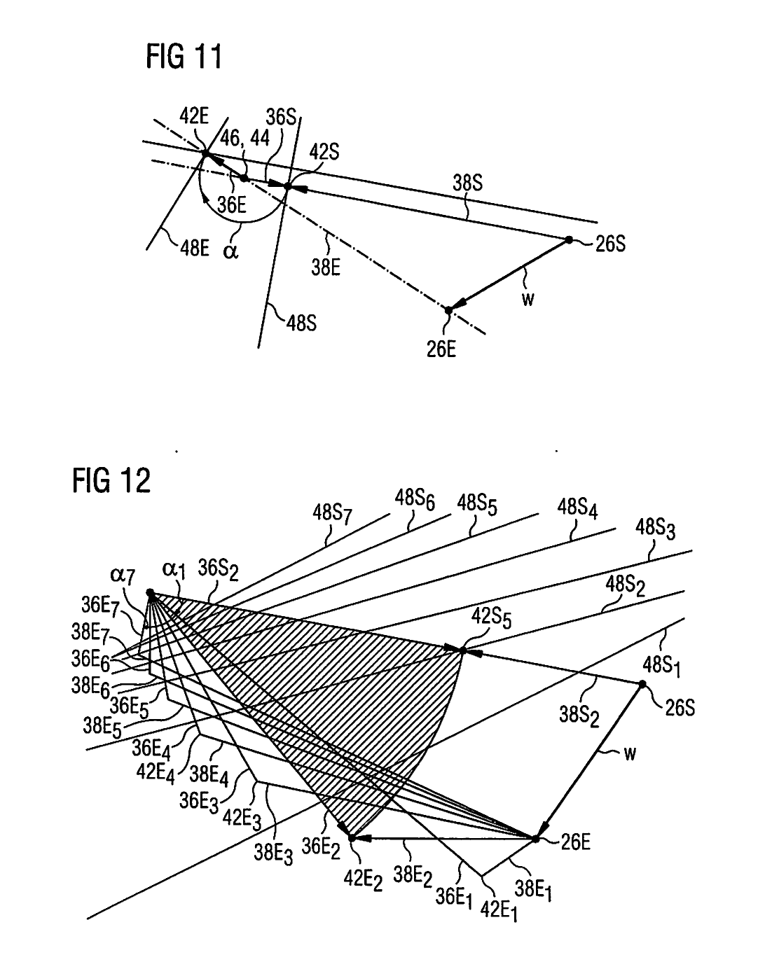

FIG. 11 a lever kinematics for a rotational angle larger than 180°;

FIG. 12 a representation of possible kinematics by a geometric graphical representation of isogonic lines for various rotational angles of 90°, 80°, 70°, 60°, 50°, 40°, and 30°;

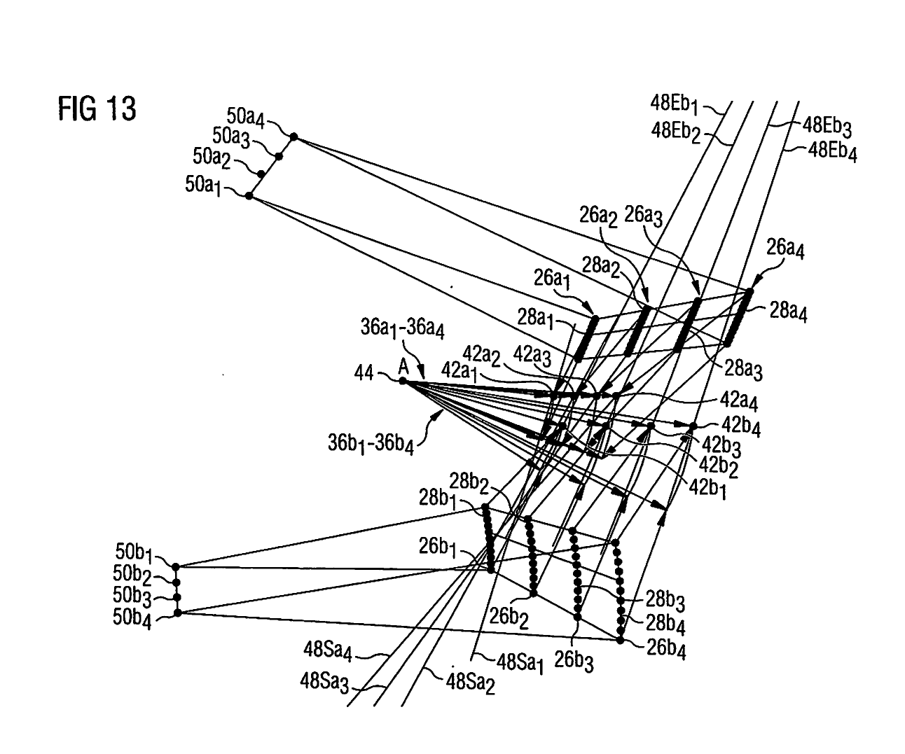

FIG. 13 a graphical representation for the use of the geometric construction of the lever kinematics in coupled sub-kinematics using the example of a solution for a flexible skin structure of a swept leading edge type shown in the profile of FIG. 1;

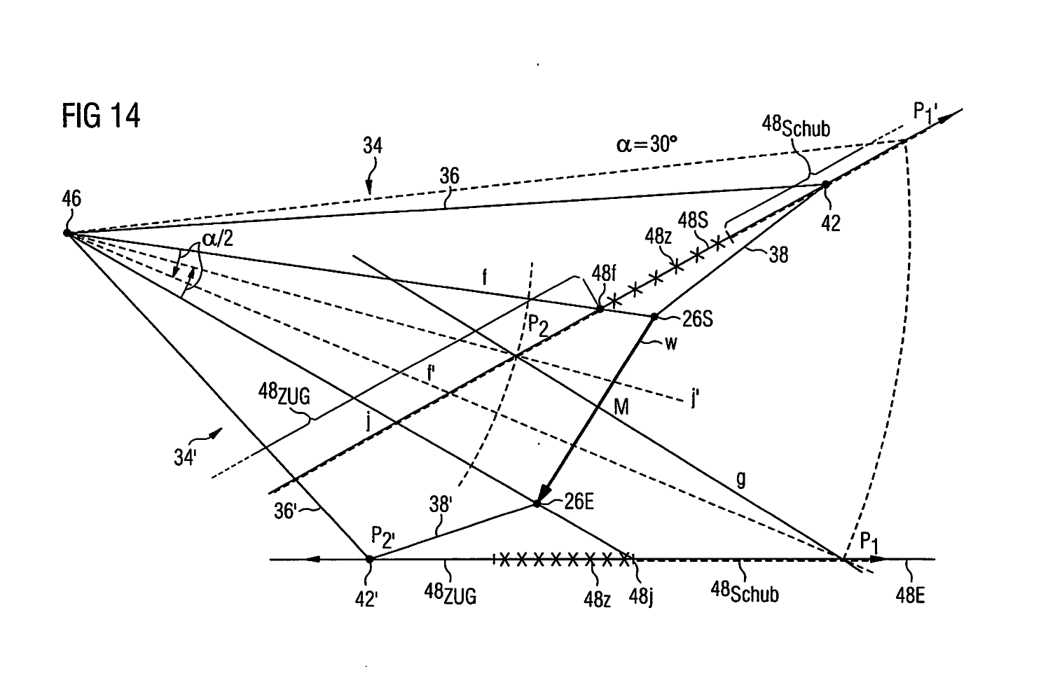

FIG. 14 a schematic diagram for explaining different stages of a possible embodiment for the determination of the possible line for the hinge points;

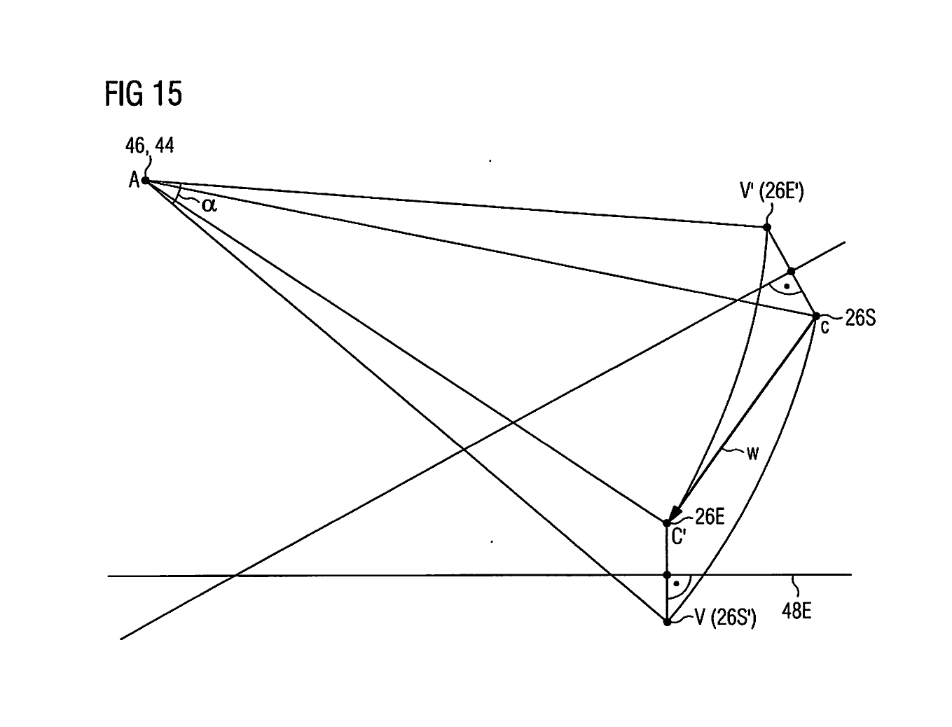

FIG. 15 schematic representations of different stages of a possible embodiment for the determination of a possible line for the hinge joints;

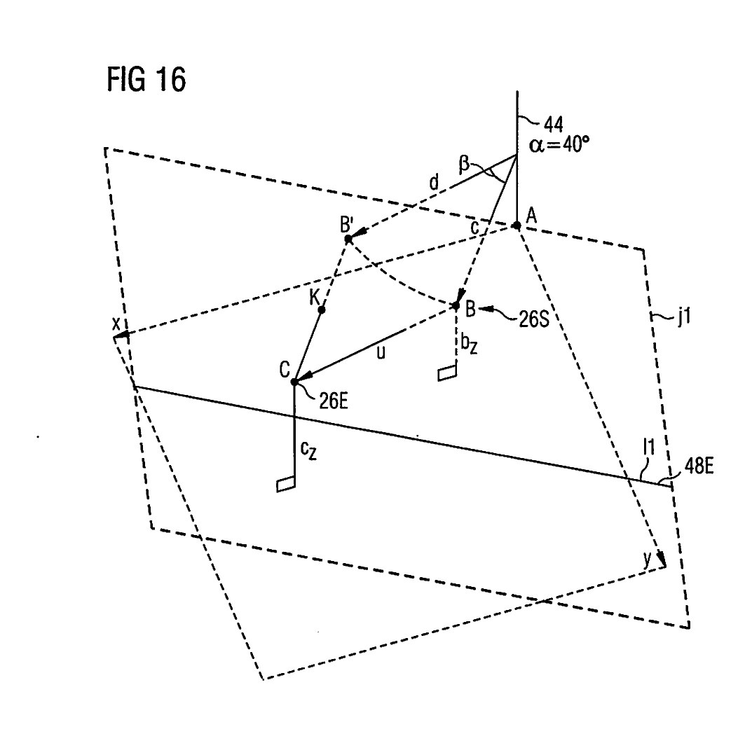

FIG. 16 a schematic diagram for a simple solution of a construction of a lever kinematics for a three-dimensional movement;

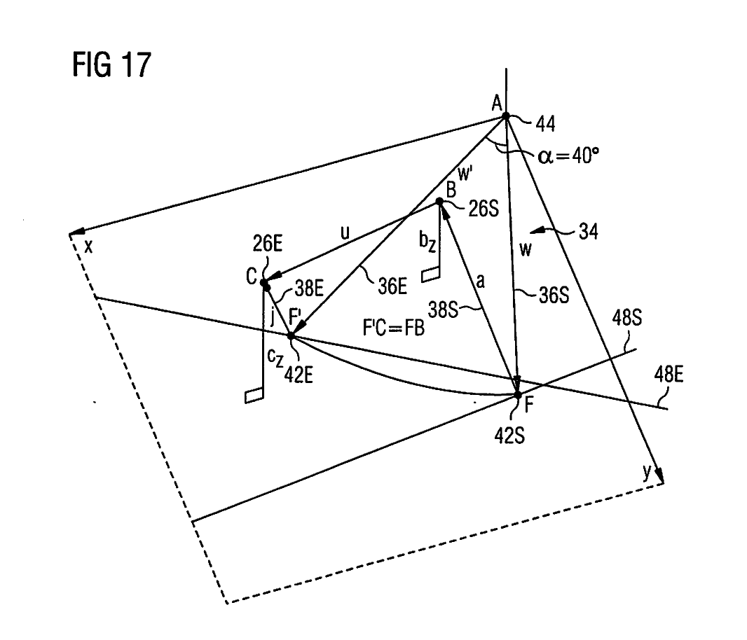

FIG. 17 a schematic representation of a selection of an arbitrary point on the isogonic line obtained by the construction of FIG. 16 in order to obtain a possible kinematics at the given initial situation;

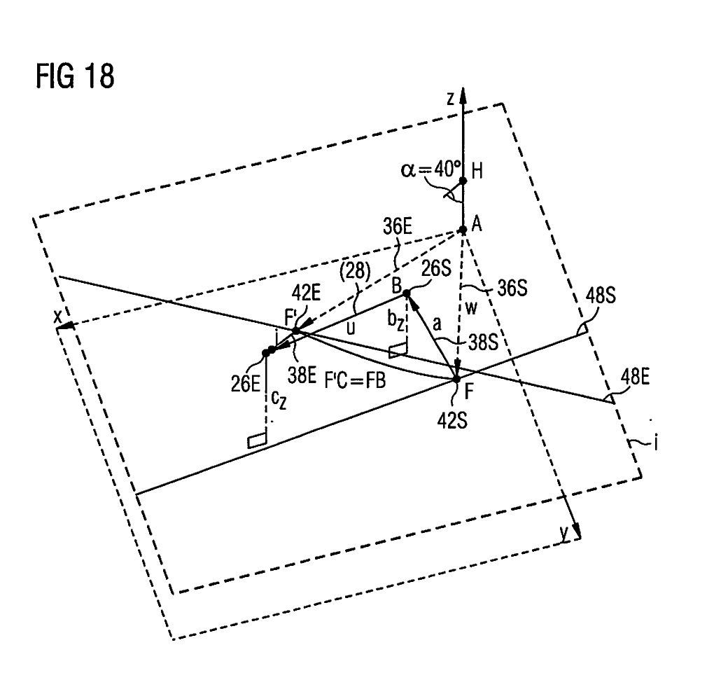

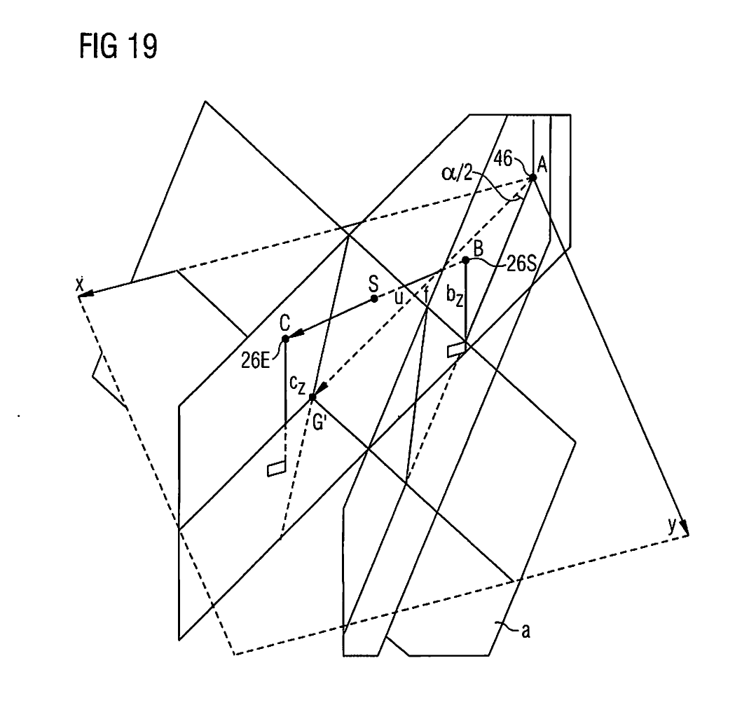

FIG. 18 a schematic perspective representation of the construction similar to that according to FIG. 16, with the initial situation slightly modified;

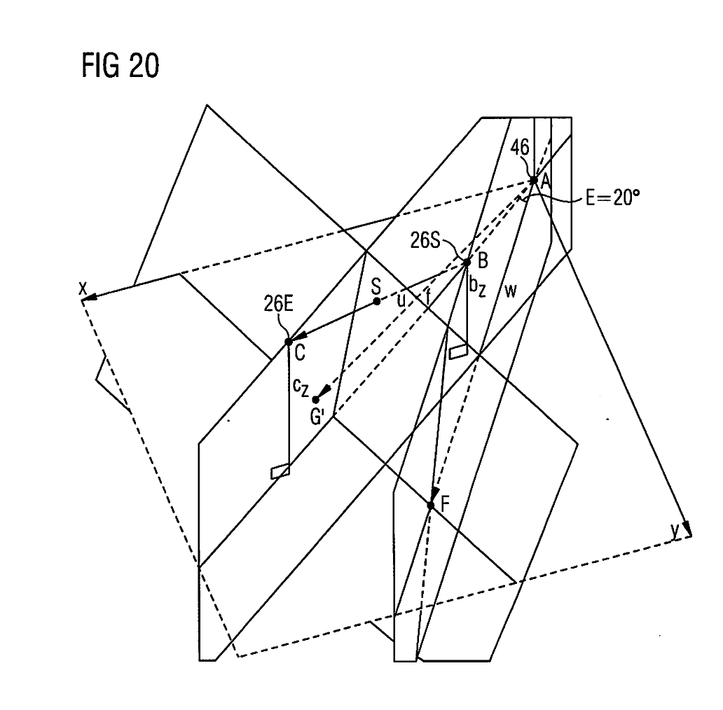

FIG. 19 a schematic representation of a method for the determination of isogonic lines similar to the method of FIG. 14, for a three-dimensional initial situation, showing the construction of a first initial point on an isogonic line;

FIG. 20 in the constellation shown in FIG. 19, the construction of a second initial point on the isogonic line in order to fix the isogonic line; and

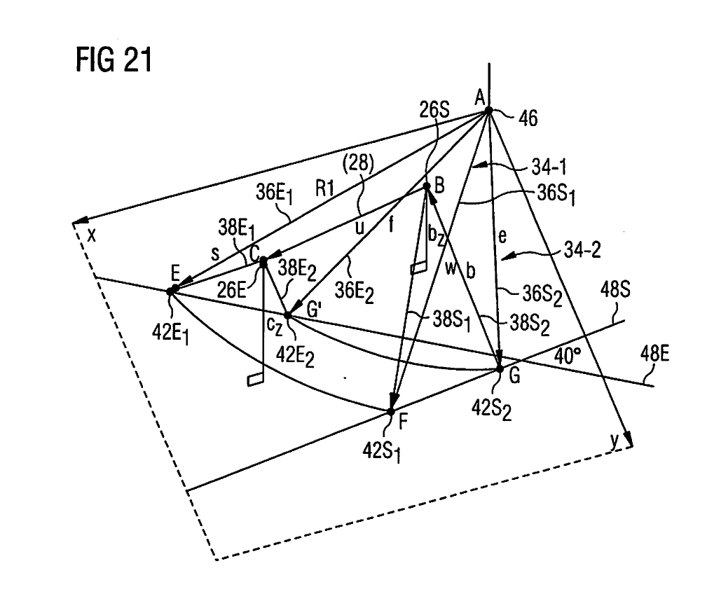

FIG. 21 starting from FIG. 20, the selection of hinge points for constructing various possible lever kinematics.

In the following, novel construction methods for the construction of lever kinematics will be described which may be used in the construction of lever mechanisms, especially for driving control surfaces of aircrafts but also for other components, especially those of aircrafts.

One example of use in a lever kinematics to be constructed is shown in more detail in FIG. 1. FIG. 1 shows an adaptive thin-walled structure 10 with a deformable structural component 12 on a fluid-dynamical flow body 14 with a load-introducing device 16, wherein said load-introducing device 16 includes an overall lever kinematics 18 in order to provoke the deformation of the adaptive structure 10. The overall lever kinematics is in turn driven by a lever drive unit 19. The overall lever kinematics 18 includes several coupled lever kinematics, each constituting a first example of a lever kinematics to be constructed. The lever drive unit 19 constitutes a further example of a lever kinematics to be constructed.

In one embodiment, the flow body 14 is a wing 15, which forms part of a windmill of a wind power plant for electric current generation. FIG. 1 shows the section through the leading edge or preferably through the trailing edge of the wing 15 of the windmill.

In a different configuration, the flow body 14 is for example a wing 15 or a fin of an aircraft such as an airplane. In this case, the wing 15 is provided with a droop nose flap that is implemented by said adaptive structure 10.

Especially in laminar profiles, it is of major importance that the flow on the wing has a particularly long laminar migration distance in every phase of the flight—different angles of attack and different flow rates. In a laminar profile, if one did without an adaptive front nose, a higher touch-down speed for landing the aircraft would be required for example in order to guarantee that the airplane is securely guided.

For this purpose, the embodiment illustrated in FIG. 1 shows a lowerable leading edge having a flexible skin 20 that is to be deformed. When lowering the leading edge, the structure 10 is deformed in such a manner that the region of the smallest curvature radii on the wing leading edge travels downwards, which is similar to an action of unrolling the skin structure. A good deformability of the skin is obtained for example by selecting suitable materials and a thin-walled skin structure. It is particularly advantageous if the flow body 14—e.g. the wing of the aircraft—is formed entirely without gaps so that the outer skin is movable without any gaps between a cruise position 22 and high-lift position 24.

Such droop noses are shown for example in the European patent application 13 196 990.9-1754 and in DE 29 07 912 A1.

For this purpose, the flexible skin 20 is fixed with its two terminal edges oriented in the span-wise direction to a supporting structure and is braced in the span-wise direction by bracing elements such as stringers, in particular omega stringers 25, but is deformable upwards and downwards. To this end, a deforming force is transmitted to the flexible skin 20 by a load-introducing device 16, with the force application points being preferably selected on the bracing elements.

To be able to implement such a leading edge on an aircraft, load-introducing devices 16 have to be constructed which correctly introduce the load for deforming the skin 20.

On the other hand, a particularly slim construction of the flow body 14 is desired. The space is therefore very limited.

Load-introducing devices 16 have to be effective along the whole length of the adaptive structure 10 that is to be deformed. A corresponding construction of the load-introducing device 16 creates problems for the design engineers.

Problem: “Morphing skin”

For the structural deformation of flexible skin structures 10 such as for gap-free high-lift configurations on wing leading edges, curved paths 28a, 28b, 28c, 28d have to be traced at distributed force application points 26a, 26b, 26c, 26d to lower the wing leading edge in order to obtain the desired target contour. The two profile contours for the flight conditions “cruise 22” and “high-lift” 24 essentially determine the design just as the smooth lowering action. The definition of the paths 28a, 28b, 28c, 28d can take place through time-discretized path points or through geometric approximation functions.

The introduction of the force into the skin structure 10 takes place at different span-wise positions (sections—one thereof being shown in FIG. 1, FIG. 1 shows a section at right angles to the trailing edge or in the flight or moving direction) with force application points 26a, 26b, 26c, 26d respectively distributed in turn in the intersection. To reduce the complexity of the entire system, an actuation mechanism 30 for performing the lowering action should be coupled in an effective manner: It is desired that the individual kinematic subsystems 34a, 34b, 34c, 34d (each including one force application point 26a, 26b, 26c respectively 26d) be operated jointly and synchronously with only one central (rotary) drive unit 32 if possible.

For each intersection, various connecting struts 38a, 38b, 38c, 38d, which are connected to the force application points 26a, 26b, 26c, 26d, are attached to a main lever 36.

In FIG. 1 for example, several force application points 26c, 26d are arranged in the region of the lower side of the flow body in FIG. 1, and several force application points 26a, 26b are arranged in the region of the upper side of the flow body in FIG. 1.

Ideally, adjacent main levers 36—arranged for example on adjacent sections in the span-wise direction of the wing 15—should be connected (e.g. through a shaft or a rod assembly).

In FIG. 1, the installation space 40 for the entire lever kinematics 18 is indicated by the boundary of the skin 20. In FIG. 2, a simple lever kinematics 34 is shown as an example of one of the sub-kinematics 34a-34d. Between the connecting struts 38a-38d and the main lever 36, the hinge points 42a, 42d have to be selected cleverly. Accordingly, the length LH of the main lever, the length LVa-LVd of the connecting struts 38a-38d, the position of the main axis 44 which the main lever 36 pivots about, and the rotational angle α within which the main lever 36 has to be moved for travelling the paths 28a-28d, are to be chosen.

In the following, there will be described the construction methods the design engineer may use for the construction and production of such lever kinematics 34.

In the illustrated embodiment, several connecting struts, e.g. the second, third and fourth connecting strut 38b, 38c, 38d, engage on a common second hinge point 42b, whereas only one connecting strut engages on a first hinge point 42a. For example, the first connecting strut 38a engages on the first hinge point 42d. The hinge points 42 of the respective connecting struts 38 can also be chosen differently.

For constructing, it makes sense to divide the entire lever kinematics 18 into several sub-kinematics 34a-34d and to determine the parameters of the sub-kinematics 34a-34d as described in more detail below.

FIG. 2 shows one of the sub-kinematics 34a-34d as the lever kinematics 34 to be constructed with the main lever 34 and the associated connecting strut 38 and the correspondingly associated force application point 26 and the associated path 28. The position of the force application point 26 at the beginning of the path or path 38—for example in the cruise position 22—is designated in the following by reference numeral 26S, and the position of the force application point 26 at the end of the path—for example in the high-lift position—is designated in the following by reference numeral 26E.

The overall lever kinematics 18 is defined through the parameters:
axis of rotation or main axis 44 (support point 46 in the sectional views) of the main levers 36 (ideally in alignment for all sections),
hinge node or hinge point 42 of the connecting struts 38 (individually different),
rotational angle α of the main levers 36 (ideally identical for all sections).

The common rotational angle α of the rotary drive unit 32 which is mostly freely selectable and essentially determines the position of the hinge node 42 of the connecting struts 38, plays a central role.

Specifications to be considered are:
the mass: determines the number of the steps (kinematic stations), the number of the strut connections (number of the kinematic sub-systems) and the length LV of the connecting struts 38,
the installation space 40: determines the position of the kinematic points 26, 42, 46,
The stiffness: determines the range of the angle between the main lever 36 and the connecting strut 38 and between the connecting strut and the skin structure.

Cause and effect are interchangeable for most kinematics. Accordingly, if the arrangement is identical, it is also possible to let the introduction of forces take place via path 28 (cause), which causes a rotary movement of a (main) lever 36 (effect).

For this purpose, there are composed in a span-wise section in the FIGS. 1 and 2 the parameters to be determined for the description of the problem of the 2D sub-kinematics using the example of a lever kinematics 34.

The rotational angle α is a function dependent on the coordinates of the axis of rotation 44, the hinge node 42, the position 26S of the force application point 26 at the point of time tStart, and the position 26E of the force application point at the point of time tEnde of the path 28.

The path 28 of the force application point 26 can be straight, curved or any shape provided that the rotational movement of the main lever 36 is always in the same direction.

A classical approach for finding the kinematic points 26, 42, 46 would now be a numerical method which sets up a linear equation system for the determination of the kinematic points and for solving the equation by means of a target function, e.g. the deviation from the predetermined path. However, it turns out that the numerical approach cannot be used for challenging problems or can be used at best for fine optimization. The reason is that the influence on the solution finding is possible to a limited extent only, e.g. through additional boundary conditions, and that an unsuitable result does not allow to give information about the cause of that unsuitability—such as wrong or unsolvable boundary conditions for example.

In contrast, a geometrical approach to the solution of the problem is proposed in the following. The geometrical method allows the problem being described in a convenient and clear manner and permits selective influence on the solution finding.

To this end, the overall problem of constructing the overall lever kinematics 18 is divided into sub-problems of constructing lever kinematics 34 of the sub-kinematics 34a-34d. To this end, the position of the axis of rotation 44 of the main lever 36, the rotational angle α of the main lever 36, a first support point, e.g. the end point 26E, on the path 28 are predetermined. For these parameters, a line including the locus of all allowable hinge points 42 of the connecting strut 38 is obtained and graphically represented as an interim result.

This is shown in FIG. 3, in which the dashed line 48 indicates all loci of all allowable hinge points for the specified rotational angle α, the specified support point 46 of the main lever 36, and the specified starting point 26S and the specified endpoint 26E. Further illustrated is an example of a possible main lever 36S at the start and the position of the same main lever at the end 36E. The pos. 38S and 38E show an example of the associated connecting strut.

Since the main lever 36 rotates about the angle α during the movement, the line 48 of all allowable hinge points is also rotated in a corresponding manner at the end of the path 28. The bold line 48S accordingly shows the line 48 of all possible hinge points at the beginning of the movement (tStart), and the line 48E, which is not plotted as a bold line, accordingly shows the line 48 of all allowable hinge points at the end of the movement (tEnde).

Geometrically, all possible hinge nodes that meet the predetermined conditions lie on a straight line. If the axis of rotation is fixed, the position of the straight line exclusively depends on the amount of the rotational angle α. Since a curve with same angle is also referred to as isogonic line, this term is also used in the following for the curve or line 48, 48S, 48E of the possible hinge nodes.

In principle, all points on the isogonic line 48, 48S, 48E represent practical solutions for fixing the hinge point 42 and accordingly for constructing the lever kinematics 34 with which the force application point 26 can be moved from its start position 26S to its end position 26E by rotating the main lever 36 about the angle α. Certain deviations are possible, especially in flexible structures. However, some possible regions on the isogonic line will be excluded or will appear less favorable due to the additional boundary conditions. After one or several isogonic lines 48 are determined, a particularly suitable hinge point 42 can be selected on an isogenic line 48, which hinge point accordingly defines the overall kinematic system.

With this method it can be readily seen whether practical hinge points for a desired rotational angle are possible within the desired installation space. If this is not the case, either the rotational angle needs to be changed or the axis of rotation shifted.

Accordingly, this provides a simple and very clear method for constructing the lever kinematics 34.

As already explained above, FIG. 3 shows the line 48 of all allowable hinge points for a given first support point, i.e. for a given first position 26S of the force application point 26 at the point of time t_{Start} of a path 28 and for a given second support point, i.e. a given second position 26E of the force application point 26 at the point of time t_{Ende} of the path 28, for a given rotational angle α of the main lever 36 and for a given axis of rotation 44 of the main lever 36, wherein 48S indicates the line at the point of time t_{Start} and the line 48E represents the same line 48 at the point of time t_{Ende}, hence after the rotation of the main lever 36 about the axis of rotation 44 by the angle α. The way in which lines 48S or 48E are obtained, will be described in more detail further below using several examples.

FIG. 3 accordingly illustrates a construction method for constructing a lever kinematics 34, which comprises a main lever 36 and at least one connecting strut 38, wherein said main lever 36 can be rotated about a main lever axis of rotation 44 by a predetermined angle α and wherein said connecting strut 38 connects a force application point 26 to a hinge node 42 on the main lever 36 and wherein a first position 26S is predetermined at the beginning of the angle of rotation α, and a second position 26E of the force application point 26 is predetermined at the end of the angle of rotation, said construction method comprising the step:
a) Representing a line 48, 48S, 48E of the possible hinge points 42 for the given rotational angle α, the main axis 44 and the first and the second position 26S, 26E of the force application point 26.

The line 48, 48S, 48E then serves as a selection guide or model for the selection of possible hinge points.

In a preferred embodiment, the construction method further comprises the step:
b) Selection of the hinge node 42 on line 48, 48S, 48E.

If the hinge node 42 is selected on the line 48, the related main lever 36 can be geometrically represented at the beginning and at the end of the angle of rotation α, wherein the connecting strut 38 indicates the connection of the hinge point or hinge node 42 to the first position 26S and the second position 26E of the point of application 26 at the beginning and at the end of the angle of rotation α, as shown in FIG. 3.

Accordingly, it can be immediately recognized graphically from FIG. 3 whether the selected kinematic points 44, 42, 26S, 26E, 42S, 42E satisfy the boundary conditions for the construction which have been stated above by way of example.

Therefore, for the construction method, the angle of rotation α and the support point 46 and a first position 26S and a second position 26E of the force application point 26 have to be fixed at first.

The selection of the position 26S, 26E of the force application point 26 is predetermined for example by a desired path 28 such as one of the paths 28a-28d for the respective sub-kinematics 34a-34a according to FIG. 1.

In a lever kinematics 34 to be constructed, it may be desired that a third support point is approached by the movement of the force application point 26 in addition to said two specified support points 26S, 26E of the path 28. For example, as illustrated in FIG. 4, the movement from a first support point to a second support point and further to a third support point is predetermined. In this case for example, a starting point 26S for the force application point 26, an intermediate position 26Z for the force application point 26, and an end position 26E for the force application point 26 have to be approached. In such a case, the isogonic lines 48 for a movement between the first pair of support points 26S, 26Z and a first sub-angle α1 and the isogonic lines 48 for a movement between the second pair of support points 26S, 26E and the second sub-angle α2 are determined. Advantageously, the point of intersection of the isogonic lines 48-1 and 48-2 thus determined is to be selected as the hinge point 42.

Concerning this, two examples are shown in FIG. 4, namely one for a thrust rod solution such as it could be realized in the sub-kinematics 34c and 34d, and one for a tension strut solution such as it could be realized in the sub-kinematics 34a and 34b of FIG. 1. The reference numerals for the tension strut solution are put in brackets.

If the path 28 of a sub-kinematics 34 is defined over more than two support points 26S, 26Z, 26E, 26-1, 26-2, it is theoretically possible to use arbitrary combinations of support points 26S-26-Z, 26S-26-1, . . . as starting points and endpoints with associated angles of rotation, and to represent a respective isogonic line.

For the application example of a construction of a load-introducing structure for a control surface of an aircraft shown in FIG. 1, the most relevant support points are those for the flight conditions “cruise” 22 and “high-lift” 24, although these need not necessarily be the starting point 26S and the endpoint 26E of the path 28.

In coupled sub-systems such as in the sub-kinematics 34a-34d, the hinge point 42a, 42b of the connecting strut 38a-38d should coincide with the point of intersection of the isogonic line in order not to produce structural constraint forces. As a prerequisite, the support points of the individual paths 28a-28d should correlate with each other time-wise. Especially in the example of FIG. 1, the avoidance of constraint forces in the skin structure is a criterion.

If the connected structure 10 is elastically deformable and if constraint forces are largely insignificant, the kinematics can be designed alone by relevant support points (e.g. start 26S and end 26E and/or cruise 22 and high-lift 24). The result is a great variety of kinematic solutions that can be constrained by further criteria.

Further criteria are for example:
similar hinge points,
similar strut length,
orientation of the strut as collinear to the force direction as possible
. . .

For example, the path 28 could be predetermined using eight points, but in an elastically connected structure it is not sufficient to identify merely relevant support points, namely the terminal points of the path 28 at the beginning 26S and at the end 26E.

Based on FIG. 3, quite different kinematic solutions are obtained as a result, depending on the selection of the position of the hinge point 42 on the isogonic line 48. Possible kinematic solutions will be described in more detail on the basis of the illustrations in the FIGS. 5 to 12.

In the FIGS. 5 to 12, similarly positioned support points 26S and 26E or similar paths 28 are to be approached.

In the FIGS. 5 to 8, an angle of 28° is respectively stated as an angle of rotation α about the axis of rotation 44, wherein the force application point 26 is supposed to move from the starting point 26S to the endpoint 26E on a corresponding rotation of the main lever 36 by this angle of rotation. Accordingly, the parameters: angle of rotation, position of the axis of rotation, starting point and endpoint, are the same in all solutions that are shown in the FIGS. 5 to 8. Merely the selection of the hinge node 42 on the line 48 is different.

The FIGS. 5 and 6 show tension struts, i.e. the connecting strut 38 is subjected to tensile load during the rotation of the main lever 36. FIG. 6 shows the limit case in which the main lever 36 and the connecting strut 38 lie on one line at the starting time t_{Start}. The limit for the selection of the hinge point 42 for a tension strut solution is accordingly constituted by the direct line Lₛ between the axis of rotation 44 and the starting point 26S, which are indicated by the dashed lines in the FIGS. 5 and 6. If a hinge point 42 is selected on the isogonic line 48S in the part 48_{zug} which extends from the point of intersection between the isogonic line 48S of the connecting line 44-26S (L_{S}) in the direction of rotation, a tension strut solution will be obtained.

On the other hand, a thrust rod solution is shown in FIG. 7. It is advantageous for the selection of the thrust rod solutions to select the hinge point 42 on the isogonic line 48E at the end of the rotation, namely in the part 48_{Schub} on this isogonic line 48E which extends against the rotational direction from the point of intersection of this isogonic line 48E with the straight connecting line L_{E} passing through the fulcrum 46 and the endpoint 26E.

FIG. 8 shows a selection of the hinge point 42 in a part 48_{z} on the isogonic line 48 between the part 48_{Zug} for the tension strut solution and the part 48_{Schub} for the thrust rod solution. In this case, a changeover from the thrust load to the tension load would take place in the course of the rotation by the angle α. Such a solution is unfavorable in most cases.

As shown in FIG. 9, the main lever 36 and the force application point 26 need not necessarily move in the same direction. Here a solution in shown in which the path 28 (indicated by the direct connecting vector w between the starting point 26S and the endpoint 26E) extends from top right to bottom left, whereas the main lever 36 extends in the anticlockwise direction from bottom right to top left. Between the limit case Gₛ of an extended linkage at the starting position and the limit case G_{E} of an extended linkage at the end position there may exist allowable tension strut solutions. Examples thereof are shown in the FIGS. 9 and 10.

FIG. 11 demonstrates that even rotational angles >180° are possible. FIG. 11 shows an example of a solution in which the linkage 36-38 is extended at the start position and at the end position.

A lever kinematics 34 can also be constructed in which the movement path 28 can extend parallel to the main lever 36 and to the connecting strut 38 at the starting time.

FIG. 12 shows the manner in which the position of the isogonic line 48 changes for different angles of rotation α. Here the isogonic lines 48S₁ to 48S₇ are shown for similar starting points and end points 26S and 26E, but for seven different angles of rotation α₁ to α₇.

In the following, one possibility for the construction of a coupled overall kinematics 18 as illustrated in FIG. 1 will be explained.

One possible approach of designing a coupled kinematics system 18 is as follows.

The order in which the sub-kinematics 34a-34d are designed is from particularly critical sub-kinematics which are difficult to be solved also from the constructional aspect to those which can be solved more easily. The first sub-kinematics takes the “master” function for the additional “slave” kinematics. The “master” determines the angle of rotation of the individual time-correlated support points 26S, 26E of the path 28, 28a-28d. With these predetermined angles of rotation, the isogonic lines can be represented corresponding to selected support points of a single “slave” sub-kinematics. If more than two support points are considered, more than one isogonic line can be represented. The common intersection point thereof describes the ideal hinge point.

In FIG. 1, for example, the sub-kinematics 34a could be the most difficult one, because in this case a changeover from the thrust load to the tension load is most likely to be feared, involving the danger of folding over. Accordingly, the same could fulfill the master function.

A further construction is shown in FIG. 13, which illustrates a solution for a flexible skin structure 10 of a swept wing trailing edge, wherein four lever kinematic stations 18₁ to 18₄ succeeding each other in the span-wise direction (sections through the wing leading edge) and each with two force application points 26a₁ to 26a₄ and 26b₁ to 26b₂ are to be constructed. Point A indicates the common axis of rotation 44 for the main levers 36a₁ to 36a₄ and 36b₁ to 36b4. At 50a₁ to 50a₄, the approximated centers of a circle for the movement paths 28a₁ to 28a₄ of the first force application points 26a₁ to 26a₄ are shown, and at 50b₁ to 50b₄ the approximated centers of a circle for the movement paths 28b₁ to 28b₄ of the second force application points 26b₁ to 26b4 are shown. In this case, too the order is from the most difficult sub-kinematics solution to the most simple sub-kinematics solution, as mentioned above. Further, isogonic lines 48Sa₁ to 48Sa₄ for the first sub-kinematics for the first force application points 26a₁ to 26a₄ at the starting time t_{Start} and isogenic lines 48Eb₁ to 48Eb₄ for the second sub-kinematics for the second force application points 26b₁ to 26b₄ are shown on which the ideal hinge points 42a₁ to 42a₂ or 42b₁ to 42b₂ are to be selected.

On the basis of the representation of the isogonic lines 48, a corresponding hinge point for each sub-kinematics problem can be found step by step, and the solution is graphically displayed straight away so that the design engineer can immediately assess the suitability of the selected solution on the basis of various examples of differently selected hinge points.

With the aid of corresponding plot routines or mathematical routines, which can clearly represent simple geometric figures, the corresponding lever kinematics for differently selected hinge points can be quickly identified. Dynamic geometry software programs such as available for maths lessons can be used for this purpose. With the use of dynamic geometry software it is possible to set up geometric constructions interactively on the computer. Such programs can be downloaded as freeware from the Internet. Examples are programs like “Derive”, “Mathcad”, “Cinderella”, “Geonext” or “GeoGebra”. Auxiliary algorithms thereto can be easily written in order to develop a program for representing the isogonic lines on the basis of one of these programs with the aid of which the selected constructions can be promptly displayed.

The representation of the lines 48, which are herein referred to as isogonic lines, of any possible hinge points for the predetermined parameters: angle of rotation, axis of rotation, starting point and endpoint, is possible in different ways. In the following, a first possible embodiment will be described in more detail with reference to FIG. 14. In this case, a movement of the force application point 26 from the starting point 26S to the endpoint 26E shall take place when the main lever 36 is rotated by an angle α (in the present case approx 30°) in the clockwise direction about the fulcrum 46.

To this end, the fulcrum 46 and the starting point 26S and the endpoint 26E in the xy plane are fixed at first using for example one of the above-mentioned software programs. In the following example, the angle of rotation in the clockwise direction is assumed to be 30°.

Thereafter, the vector w from the point 26S to the point 26E as well as the straight line f through the fulcrum 46 and the starting point 26S, the straight line g through the center M of the vector w and perpendicular to the vector w in the xy plane, and the straight line j through the fulcrum 46 and the endpoint 26E are plotted.

Then the straight line f is rotated about the fulcrum 46 in the direction of rotation by the angle α/2, which results in the straight line f. In a comparable manner, the straight line j is rotated in the opposite direction by half the angle of rotation α/2, which results in the straight line j′. The point of intersection between f and g is for example referred to as P₁, the point of intersection between j′ and g is for example referred to as P₂.

Thereafter the point P₁ is rotated by −α, i.e. by a in the opposite direction, which results in point P₁′. The point P₂ is rotated by the angle of rotation α in the direction of rotation, which results in point P₂′.

Point P₂ is one of the possible hinge points if the system is at the starting of time. P₁ is one of the possible hinge points if the system is at the ending time. The isogonic line 48S at the starting f time is thus given as a straight line through the point P₂ and the rotated point P₁′, whereas the isogonic line 48E is given as a straight line through the point P₁ and the point P₂′ rotated by α.

The above construction of the isogonic line is based on the consideration that the straight line g represents the sum of all points which have the same distance to 26S and 26E. If half the angle of rotation is completed and a point is reached which has the same distance to the starting point 26S as to the endpoint 26E, this is a possible point for a hinge node. In the same manner, half the angle of rotation is to be completed in point P₂; on the other hand, point P₂ is equally spaced from the starting point 26S and from the endpoint 26E. Thus the points P₁ and P₂ are possible hinge points for the initial state or the final state. Corresponding rotations by the angle α will then result in an additional possible hinge point for the final state or the initial state.

The present illustration of the isogonic line 48 according to FIG. 1 is thus based on the consideration of the line symmetry. Other geometric constructions are also possible, e.g. with the aid of the ellipse tangent or the hyperbolic tangent. Even numerical solutions of two points each on the isogonic line are possible in order to be able to represent the isogonic lines 48 in a corresponding manner.

After the isogonic lines 48E, 48S are represented as shown in FIG. 14, it is still required to select a suitable hinge point 42 on the isogonic lines 48E, 48S.

To this end, it may be considered whether a thrust rod or a tension bar is desired.

The straight line f represents a case of an extended linkage—main lever 36 and connecting strut 38 on one line—at the starting point 26S. Accordingly, the point of intersection 48f of the straight line f with the isogonic line 48S is the locus for the hinge point 42 for this limit case of a tension strut solution.

The straight line j represents the limit case of an extended linkage—main lever 36 and connecting strut 38 on one line—for the endpoint 26E. Accordingly, the point of intersection 48j of the straight line j with the isogonic line 48E represents the limit case for this final state, for an allowable hinge point 42 for the thrust rod solution. Accordingly, the regions 48_{Zug} and 48_{Schub} indicated by the additional dashed lines are possible positions of hinge points 42 for a thrust rod solution or a tension strut solution. The region 48_{z} in between should be avoided. This is indicated in FIG. 14 by crosses in the region 48_{z}.

In FIG. 14, merely two possible solutions for the lever kinematics 34, 34′ are plotted, wherein in the lever kinematics 34 including the lever 36, the hinge point 42 and the connecting strut 38, a thrust rod solution has been chosen and is illustrated in the initial position, and wherein in the lever kinematics 34′ including the main lever 36′, the hinge point 42′ and the connecting strut 38′, a tension strut solution in the position at the end of the movement is shown. In both lever kinematics 34, 34′, a rotation of the main lever 36, 36′ by the angle of rotation α (in the present case 30°) in the clockwise direction about the common fulcrum 46 results in a movement of the force application point 26 from the start position 26S to the end position 26E.

In the above description, solutions for the construction of lever kinematics have been discussed, wherein the lever and the connection strut and also the movement lie in one plane. However, the invention is not limited to this. The solution, which involves isogonic lines, can also be used for three-dimensional kinematic problems still to be described in more detail below.

The approach of deriving and representing the isogonic lines 48 chosen in the construction according to FIG. 14 involves considerations about symmetry with respect to a line. The thought behind this is that the length of the connecting strut 38 at the starting point 26S and at the endpoint 26E is symmetrically reflected across an axis.

Accordingly, a line perpendicular to the connection between both force application points 26S and 26E is plotted on the basis of the parameters, namely the two force application points and the locus of the main axis of rotation A.

The thought behind this construction is that when the axes are respectively reflected by α/2, i.e. half the angle of rotation, the same length of the connecting strut 38 must be given on the left and on the right. With this construction principle, the isogonic lines for the start 48S (the entire system is at the starting point) and for the end 48E (the entire system is at the endpoint) can be constructed.

Accordingly, the symmetry to the axes is utilized. There are defined axes where the points of equal length are given. The isogonic line is where the same intersect.

In the following, an alternative and far more simple and thus preferred approach of representing the isogonic line will be explained with reference to FIG. 15. To this end, the construction of the midperpendicular is used. In this case, the coordinate system is preferably chosen such that the rotational plane of the main lever and the plane of the connecting nodes (particularly force application points) lie in the xy plane, with the rotational axis at the origin (0, 0).

FIG. 15 shows the given initial situation with an angle of rotation α (in the present case e.g. 29°), the rotational plane (xy plane), the fulcrum 46 (A) and the path points at the start 26S and at the end 26E (C and C′) together with the vector w.

In a first step, point C—starting point 26S—is rotated by the angle α (e.g. 29°) about the fulcrum 46. The resulting point is referred to as V in FIG. 15. The midperpendicular to the connecting line C′V is constructed; this midperpendicular constitutes the isogonic line 48E at the end of the movement (isogonic line of the end position).

The isogonic line 48S at the start can then be easily obtained by simply rotating the isogonic line 48E by the angle −α about the fulcrum 46.

However, it is also possible to rotate point C′—endpoint 26E—by the angle −α(29°) about the fulcrum 46. The resulting point is referred to as V′ in FIG. 15. Thereafter, the midperpendicular to the connecting line C-V is constructed. This midperpendicular constitutes the isogonic line at the beginning of the movement 48S (isogonic line of the start position).

The thought behind this construction is as follows: The midperpendicular to a connecting line between two reference points represents the quantity of all points which have the same distance to the reference points. Accordingly, the midperpendicular to C′-V represents the quantity of all points which have the same distance to the endpoint C′ and to the starting point V rotated by α. However, points with the same distance to the endpoint and the rotated starting point are the immediate possible hinge points 42. The isogonic lines 48 are thus obtained in a very simple and universal way.

In the following, the three-dimensional solution will be finally described. Corresponding to the above-described two-dimensional solution, the isogonic lines can be also obtained in different ways. A first case, which can be used universally, results from the solution involving the midperpendicular. The second solution process, which is based on the considerations of FIG. 14, can be used only in the following second case in which the line segment 26S-26E is not orthogonal to the rotational plane, i.e. not parallel to the rotational axis. This second solution process is not applicable to cases where the connecting line 26S-26E is orthogonal to the rotational plane, i.e. parallel to the axis of rotation.

In the universal solution process (case 1), the principle of the midperpendicular can be applied. In the other solution process (case 2), the same principle of line symmetry can be used for inferring the isogonic lines 48S and 48E. In this manner, intersection lines are obtained. The corresponding solutions are the points of intersection of the intersection line with the rotational plane i.

The easier way for constructing the isogonic lines in the 3D case, which can be applied to all 3D cases including the orthogonal case and also to the 2D case—as shown in FIG. 15—will be explained in the following with reference to the FIGS. 16 to 18. The FIGS. 16 to 18 show constructions designed with the aid of a geometry program, wherein the steps and the definitions in table 1 have been used.

TABLE 1
Case 1

| No. | Name | Definition | Instruction |
|---|---|---|---|
| 1 | angle α | | |
| 2 | angle η | | |
| 3 | FIG. h | | |
| 4 | point H | (0, 0, h) | (0, 0, h) |
| 5 | plane i | plane through H normal to z axis | OrthogonalPlane[h, z axis] |
| 6 | point A | | |
| 7 | point B | | |
| 8 | point C | | |
| 9 | straight line e | line in the 3D space through C, intersects | Vertical[C, z axis, space] |
| | | and is perpendicular to z axis | |
| 10 | point E | intersection point of z axis, e | Intersect[z axis, e] |
| 11 | straight line r₁ | straight line through B perpendicular to i | Vertical[B, i] |
| 12 | straight line r₂ | straight line through C perpendicular to i | Vertical[C, i] |
| 13 | point M | intersection point of r₁, i | Intersect[r₁, i] |
| 14 | line segment b₂ | line segment [B, M] | Line segment[B, M] |
| 15 | angle δ | angle between r₁, i | Angle[r₁, i] |
| 16 | point N | intersection point of s₁, j | Intersect[s₁, j] |
| 17 | line segment c₂ | line segment (C, N) | Line segment[C, M] |
| 18 | angle γ | angle between s₁, j | Angle[s₁, j] |
| 19 | vector u | vector [B, C] | Vector[B, C] |
| 20 | straight line b | line in the 3D space through B, intersects | Vertical[B, z axis, space] |
| | | and is perpendicular to z axis | |
| 21 | point D | intersection point of z axis, b | Intersect[z axis, b] |
| 22 | vector c | vector [D, C] | Vector[D, C] |
| 23 | point B′ | rotated by angle −α about z axis | Rotate[B, −α, z axis] |
| 24 | vector d | vector [D, B′] | Vector[D, B′] |
| 25 | angle β | angle between B, D, B′ | angle[B, D, B′] |
| 26 | arc g | arc [D, B, B′] | Circular arc [D, B, B′] |
| 27 | line segment v | line segment (C, B′) | Line segment[C, B′] |
| 28 | point K | center of C, B′ | Center[C, B′] |
| 29 | plane j₁ | plane through K normal to v | OrthogonalPlane[K, v] |
| 30 | straight line l₁ | intersection line of j₁, i | IntersectPaths[j₁, i] |
| 31 | point C′ | C rotated by angle α about z axis | Rotate[C, α, z axis] |
| 32 | vector s | vector [E, C′] | Vector[E, C′] |
| 33 | vector f | vector [E, C] | Vector[E, C] |
| 34 | arc k | arc[E, C′, C] | Arc[E, C′, C] |
| 35 | angle ζ | angle between s, f | Angle[s, f] |
| 36 | line segment t | line segment [C′, B] | Line segment [C′, B] |
| 37 | point L | center of C′, B | Center[C′, B] |
| 38 | plane o1 | plane through L normal to t | OrthogonalPlane[L, t] |
| 39 | straight line q₁ | intersection line of i, o₁ | IntersectPaths[i, o₁] |
| 40 | point F | point on q₁ | Point[q₁] |
| 41 | vector w | vector [A, F] | Vector[A, F] |
| 42 | vector w′ | w rotated by angle −α about z axis | Rotate[w, −α, z axis] |
| 43 | point F | F rotated by angle −α about z axis | Rotate[F, −α, z axis] |
| 44 | angle ε | angle between w, w′ | Angle[w, w′] |
| 45 | arc p | arc [A, F, F′] | Arc[A, F, F′] |
| 46 | vector a | vector [F, B] | Vector[F, B] |
| 47 | vector j | vector [F′, C] | Vector[F′, C] |
| 48 | figure | distance between F′ and C | Distance[F′, C] |
| | distance F′C | | |
| 49 | text text F′C | ““+(name[F′] + (name[C])) + “=” + name[F] + | ““+(Name[F′] + (Name[C])) + |
| | | (name[B]))+”” | “=” + Name[F] + (Name[B]))+”” |
| 50 | figure | distance between F and B | Distance[F, B] |
| | distance B | | |

In the method for the determination of the isogonic lines for the general 3D case (also applicable to 2D) according to the FIGS. 16 and 17, the connecting line of the path points can be arranged with respect to the rotational plane (both non-perpendicular and perpendicular to each other) in an arbitrary manner.

A precondition is a coordinate transformation in order to achieve that
the axis of rotation of the main lever corresponds to the z axis,
the fulcrum is at the origin (0, 0, 0),
the plane of the connecting nodes is arranged on the xy plane or parallel thereto.

At the given initial situation, the exemplary rotational angle alpha)(=40°, the rotational plane (xy plane), the axis of rotation (z axis), the fulcrum (A), and the path points at the start and at the end (B=26S and C=26E) are shown.

Step 1: Construction of the center K
B′: rotating point B by the angle −alpha
K: center between B′ and C

FIG. 16 shows step 2: Construction of the first isogonic line I1
j1: normal plane through K with normal vector v
=symmetry plane between B′ and C
straight isogonic line I1: line of intersection between j1 and rotational plane i (in the present case identical with xy plane)

The straight isogonic line 11 represents the isogonic line 48E at the ending time t_{Ende}. The isogonic line 48E can be simply obtained by rotating line 48E by the angle −alpha about the rotational axis (=z axis).

Step 3 can also be performed: Construction of the center L
C′: rotating point C by the angle alpha
L: center between B and C
   and subsequently step 4: Construction of the second isogonic line q1
o1: normal plane through L with normal vector t
=symmetry plane between B and C′
straight isogonic line q1: line of intersection between o1 and rotational plane i (in the present case identical with xy plane)

FIG. 17 shows a selection of an arbitrary point (F) as the hinge point 42S on the isogonic line 48S and the rotation by alpha (F′)—hinge point 42E. In this manner, a possible kinematics 34 at the given initial situation is obtained.

In FIG. 18, the following initial situation, which is different from FIG. 17, is assumed: rotational angle alpha)(=40°, the rotational plane i runs parallel to the xy plane through H, the rotational axis is the z axis, the fulcrum (A) or bearing of the main lever passes through the origin, further shown are the path points 26S, 26E at the start and at the end (B and C).

The construction takes place as previously described, but the planes o1 and j1 do not intersect the xy plane, but instead the rotational plane i, which runs parallel to the xy plane and through point H.

FIG. 18 shows the finished construction similar to FIG. 17 in the correspondingly modified initial situation in a perspective with the plane i.

In the following, case 2 will be explained with reference to the illustration in the FIGS. 19 to 21. In table 2, the individual steps that are performed using a geometry program are listed together with the definitions of the points, lines and planes shown in the FIGS. 19 to 21.

TABLE 2
Case 2

| No. | Name | Definition | Instruction |
|---|---|---|---|
| 1 | angle α | | |
| 2 | FIG. h | | |
| 3 | point A | | |
| 4 | plane i | plane through A normal to z axis | OrthogonalPlane[A, z axis] |
| 6 | point B | | |
| 7 | straight line b₁ | line through B perpendicular to i | Vertical[B, i] |
| 8 | point E | intersection point of b₁, i | Intersect[b₁, i] |
| 9 | line segment b₁ | line segment [B, E] | Line segment[B, E] |
| 10 | angle γ | angle between b₁, i | Angle[b₁, i] |
| 11 | point C | | |
| 12 | straight line g | line through C perpendicular to i | Vertical[C, i] |
| 13 | point D | intersection point of g, i | Intersect[g, i] |
| 14 | line segment c₁ | line segment [C, D] | Line segment[C, D] |
| 15 | angle β | angle between c₁, i | Angle[c₁, i] |
| 16 | vector v | vector [A, C] | Vector[A, C] |
| 17 | vector u | vector [B, C] | Vector[B, C] |
| 18 | point S | center of C, B | Center[C, B] |
| 19 | plane a | plane through S normal to u | OrthogonalPlane[S, u] |
| 20 | plane b2 | plane through B, z axis | Plane[B, z axis] |
| 21 | straight line d | intersection line of b2, i | IntersectPaths[b2, i] |
| 22 | plane g2 | b2 rotated by angle (−α)/2 about z axis | Rotate[b2, (−α)/2, z axis |
| 23 | straight line j | intersection line of g2, i | IntersectPaths[g2, i] |
| 24 | angle δ | angle between d, j | Angle[d, j] |
| 25 | straight line d2 | intersection line of a, g2 | IntersectPaths[a, g2] |
| 26 | point G′ | intersection point of d2, i | Intersect[d2, i] |
| 27 | vector f | vector [A, G′] | Vector [A, G′] |
| 28 | plane c1 | plane through C, z axis | Plane[C, z axis] |
| 29 | straight line k | intersection line of c1, i | IntersectPaths[c1, j] |
| 30 | plane f1 | c1 rotated by angle α/2 about z axis | Rotate[c1, α/2, z axis] |
| 31 | straight line l | intersection line of f1, i | IntersectPaths[f1, i] |
| 32 | straight line d1 | intersection line of a, f1 | IntersectPaths[a, f1] |
| 33 | point F | intersection point of d1, i | Intersect[d1, i] |
| 34 | angle ε | angle between k, l | Angle[k, l] |
| 35 | vector w | vector [A, F] | Vector[A, F] |
| 36 | point F₁ | F rotated by angle (−α)/2 about z axis | Rotate[F₁, (−α)/2, z axis |
| 37 | point G | G′ rotated by angle α about z axis | Rotate[G′, α, z axis] |
| 38 | vector e | vector [A, G] | Vector[A, G] |
| 39 | point G₁ | G′ rotated by angle α/2 about z axis | Rotate[G′, α/2, z axis] |
| 40 | arc d₁ | arc of circumscribed circle [G, G₁, G′] | Arc of circumscribed circle [G, |
| | | | G₁, G′] |
| 41 | angle ζ | angle between f, e | Angle[f, e] |
| 42 | point F′ | F rotated by angle −α about z axis | Rotate[F, −α, z axis] |
| 43 | vector n₁ | vector [A, F′] | Vector[A, F′] |
| 44 | arc e, | arc of circumscribed circle [F, F₁, F′] | arc of circumscribed circle [F, |
| | | | F₁, F′] |
| 45 | angle η | angle between n₁, w | Angle[n₁, w, xy plane] |
| 46 | straight line Iso₂ | line through G, F | Straight line[G, F] |
| 47 | straight line Iso₁ | line through G′, F′ | Straight line[G′, F′] |
| 48 | angle θ | angle between Iso₂, Iso₁ | Angle[Iso₂, Iso₁] |
| 49 | vector c | vector [G′, C] | Vector[G′, C] |
| 50 | vector b | vector [G, B] | Vector[G, B] |
| 51 | vector r | vector [B, F] | Vector[B, F] |
| 52 | vector s | vector [C, F′] | Vector[C, F′] |

The FIGS. 17 to 21 illustrate a method for the determination of the isogonic lines for the case of “non-orthogonality” where the connecting line of the path points to the rotational plane is not perpendicular.

In FIG. 19, a rotational angle alpha (=40°), the rotational plane (xy plane), the axis of rotation (z axis), the fulcrum (A) and the path points at the beginning and at the end of the movement (in the present case referred to as B and C) are shown for an exemplary initial situation.

First of all step 1 is performed: Construction of the symmetry plane a between B and C.

FIG. 19 shows step 2: Construction of the first isogonic point (G′) on the first isogonic line (Iso1):
b2: plane (A, B, z axis) rotated by alpha/2
d2: line of intersection of a and b2
G′: point of intersection of d2 and xy plane

FIG. 20 shows step 3: Construction of the first isogonic point (F) on the second isogonic line (Iso2)
f1: plane (A, C, z axis) rotated by alpha/2
d1: line of intersection of a and f1
F: point of intersection of d1 and xy plane

The next step is step 4: Construction of the second isogonic point (G) on the first isogonic line (Iso1):
G: G′ rotated by the angle alpha

The next step is step 5: Construction of the second isogonic point (F′) on the second isogonic line (Iso2)
F′: F rotated by the angle −alpha

The next step is step 6: Representation of the isogonic lines
Iso1: straight line through the points F′ and G′
Iso2: straight line through the points F and G

These straight lines are represented in FIG. 21 by the points F′ and G as well as F and G′. Accordingly, both lines 48S and 48E for the usual 3D case are found, and a possible hinge point can be selected on one of these lines. Possible selections are explained in the following with reference to FIG. 21.

FIG. 21 shows step 7: Selection of the kinematics
angle alpha between main lever e and f or between w and n1 and between the isogonic lines
system 34-1: equal lengths of the main levers 36S1 and 36E1 and equal lengths of the connecting struts 38S1 and 38E1
system 34-2: equal lengths of the main levers 36S2 and 36E2 and equal lengths of the connecting struts 38S2 and 38E1.

In the following, further criteria for step b) “selection of suitable hinge points” will be explained. To this an approach exists according to which a third point N on the connecting line between the force points and an angle thereto are assumed. For example, the angle can be assumed through a ratio of the respective line segments. If N lies for example on 70% of the overall line segment, a rotational angle of 70% of the maximum angle can be assumed. Thereafter, the isogonic line problem is solved using this constellation. A suitable hinge point would for example be a point of intersection between the isogonic lines.

This is only one example. It could be provided for instance that not only the two force applications points 26S and 26E, but also a third force application point are to be approached; the problem could then be solved in this way, see FIG. 4.

A further case of the selection is illustrated in FIG. 14. In this case, there are the two examples of a tension strut and a thrust rod. At the selection of the hinge points 42, it could be considered to excluded a transition zone 48Z between pulling and pushing.

Such a transitional case could be possible in special solutions, for example for determining the overall kinematics by folding it down. In the application of the droop nose, this is not provided.

FIG. 4 shows examples, in which one selects a relatively large number of intermediate points and finds the respective solution. In this manner, one obtains for example a region of as many intersection points of the isogonic lines as possible. This region could be selected for the selection of the hinge point

The FIGS. 9 and 10 show that the rotational angle and the direction of movement need not move in the same direction; the rotation can also be in the one direction and the movement in the other, see FIG. 9. FIG. 10 shows a second illustration in which the main lever 36 is moved to the left top and the connecting strut 38 is considerably longer than the main lever. There are also limit cases in which the linkage is extended. However, this position would be rather unfavorable, because no force can be exerted.

FIG. 11 shows, that there may even be rotational angles larger than 180°.

Also, a solution is conceivable (not illustrated) in which the initial position of the connecting strut 38 is aligned with the main lever 36 and the movement path 28 is aligned as well. In the kinematics of the crank mechanism, this represents the classical thrust rod problem.

FIG. 13 shows use of the isogonic line technology to the initially described problem. Here the isogonic lines 48b₁ to 48b₂ for the lower paths (e.g. the paths 28c and 28d in FIG. 1) are given. Further, examples are shown for the upper paths 28a or 28b in FIG. 1. Some points are shown which are supposed to lie on the paths. It shows that a good point for the rotational axis has been chosen if isogonic lines are created which are as similar as possible. The individual paths approximately lie on circular paths to centers of rotation 50a, 50b.

Possible applications of lever kinematics 18, 34 to be constructed in this way are a deflection of the skin on the leading edges of wings, according to FIG. 1. For further details reference is made to European patent application 13 196 990.9-1754 (not prior published). Other possible applications are the driving of coupled systems by a common rotatable driving rod, particularly in the form of a conversion of a linear movement into a rotary movement and vice versa—indicated by the lever actuator 19. For further details reference is made to European patent application 13196994.1 (not prior published) which describes and illustrates a lever actuator 19 for the conversion of a linear movement into a rotary movement, e.g. for driving a main lever of a structure that is to be deformed in accordance with document 13 196 990.9.

Applications are for example the control of control surfaces in aircrafts. A control of other fluid-dynamically effective surfaces is also possible such as the control of a wing surface in order to influence a transition from a laminar flow to a turbulent flow using a corresponding lever kinematics. The lever kinematics 18, 34 can be constructed and used for any desired control of flaps in airplanes and aircrafts (flap elements) or also of hinge systems of doors (e.g. of aircrafts) or possibly also of running gear kinematics of vehicles and aircrafts.

Further fields of application are vehicles, for example aerodynamically effective surfaces of vehicles, ships, submarines, windmill plants etc.

A structure of the kind as shown in FIG. 1 can be used for example in a rotor blade of a windmill instead of an airfoil. By changing the flexible skin structure on a leading edge and/or trailing edge, the form of the windmill rotor plane can be quickly adjusted to changes of wind. The edges of the windmill blade can be quickly changed in order to adjust the windmill blade to the respective flow conditions. To this end, a lever kinematics can be constructed in a manner corresponding to the above-described method.

The driving action for adjusting the position of the wing edges can take place analogously to that described and illustrated in European patent applications 13 196 990.9 and 13196994.1. Particularly the linear drive unit is of great interest for windmill blades because the actuation for the adjustment of the edges can be from the hub.

### LIST OF REFERENCE NUMERALS

10 adaptive structure
12 structural component
14 flow body
15 wing
16 load-introducing device
18 overall lever kinematics
19 lever drive unit
20 flexible skin
22 cruise position
24 high-lift position
25 omega stringer
26 force application point
26a first force application point
26b second force application point
26c third force application point
26d fourth force application point
C, B, 26S position of the force application point Start
C′, C, 26E position of the force application point Ende
28 path
28a path of the first force application point
28b path of the second force application point
28c path of the third force application point
28d path of the fourth force application point
30 actuation mechanism
32 drive unit
34 lever kinematics
34a first sub-kinematics (for the first force application point)
34b second sub-kinematics (for the second force application point)
34c third sub-kinematics (for the third force application point)
34d fourth sub-kinematics (for the fourth force application point)
36 main lever
36S main lever (Start)
36E main lever (Ende)
38 connecting strut
38a first connecting strut (to the first force application point)
38b second connecting strut (to the second force application point)
38c third connecting strut (to the third force application point)
38d fourth connecting strut (to the fourth force application point)
40 installation space
42 hinge point
42a first hinge point
42b second to fourth hinge points
44 axis of rotation (main axis)
A, 46 fulcrum
48 line of all allowable hinge points (isogonic line)
48S line of all allowable hinge points (isogonic line) at the beginning of the path
48E line of all allowable hinge points (isogonic line) at the end of the path
α rotational angle
LH length of the main lever
LV length of the connecting strut
S start
E end
w, u vector from the force application point at the start to the force application point at the end

1. A construction method for constructing a lever kinematics comprising a main lever and at least one connecting strut, wherein the main lever being rotatable about a main lever axis by a predetermined angle and the connecting strut connecting a force application point to a hinge point on the main lever, and a first position of the force application point being predetermined at the starting point of the rotational angle and a second position of the force application point being predetermined at the endpoint of the rotational angle, the method comprising:
representing a line of the possible hinge points for the given rotational angle, the main axis and the first and the second positions of the force application point, as a selection guide for selecting the hinge point.

2. The construction method according to claim 1, further comprising
selecting the hinge point on the line.

3. The construction method according to claim 1, further comprising
geometrically representing the main lever and the connecting strut at the beginning and at the end of the rotational angle.

4. The construction method according to claim 1, wherein the representing includes
representing the line of possible hinge points for the beginning of the rotational angle and representing the line of the possible hinge points for the end of the rotational angle.

5. The construction method according to claim 1, wherein the representing includes
geometrically constructing the line in the form of a straight line on the basis of at least one of:
parallelism conditions;
symmetry conditions;
collinearity conditions; and
perpendicularity conditions.

6. The construction method according to claim 2, wherein the selecting includes
selecting the hinge point on the basis of boundary conditions and/or the available space for the lever kinematics.

7. The construction method according to claim 4, wherein a selection of the hinge point takes place on the basis of boundary conditions on both endpoints of the rotational angle.

8. A lever mechanism construction method for the construction of a lever mechanism arrangement with coupled lever kinematics, each of the lever kinematics comprising a main lever and at least one connecting strut such that the main lever can be rotated about a main lever axis by a predetermined angle, the connecting strut connects a force application point to a hinge point on the main lever, a first position of the force application point is predetermined at the beginning of the rotational angle, and a second position of the force application point is predetermined at the end of the rotational angle, the method comprising:
selecting the one of the lever kinematics that has to meet the majority of boundary conditions as the higher-ranking master kinematics;
carrying out the construction method according to claim 1 for the master kinematics; and
thereafter, carrying out the construction method according to claim 1 for a further coupled lever kinematics under consideration of the construction of the master kinematics as a boundary condition.

9. (canceled)

10. A production method for producing a lever kinematics comprising a main lever and at least one connecting strut, the main lever being rotatable about a main lever axis by a predetermined angle, the connecting strut connecting a force application point to a hinge point on the main lever, a first position of the force application point being predetermined at the beginning of the rotational angle, and a second position of the force application point being predetermined at the end of the rotational angle, the production method comprising:
performing the construction method in accordance with claim 1, producing the main lever and the connecting strut, and coupling the same to each other at the hinge point determined by the construction method.

11. A non-transitory computer readable medium of instructions comprising
a computer program for controlling a computer to perform the method according to claim 1.

12. The construction method according to claim 2, further comprising
geometrically representing the main lever and the connecting strut at the beginning and at the end of the rotational angle.

13. The construction method according to claim 2, wherein the representing includes
representing the line of possible hinge points for the beginning of the rotational angle and representing the line of the possible hinge points for the end of the rotational angle.

14. The construction method according to claim 3, wherein the representing includes
representing the line of possible hinge points for the beginning of the rotational angle and representing the line of the possible hinge points for the end of the rotational angle.

15. The construction method according to claim 12, wherein the representing includes
representing the line of possible hinge points for the beginning of the rotational angle and representing the line of the possible hinge points for the end of the rotational angle.

16. The construction method according to claim 2, wherein the representing includes
geometrically constructing the line in the form of a straight line on the basis of at least one of:
parallelism conditions;
symmetry conditions;
collinearity conditions; and
perpendicularity conditions.

17. The construction method according to claim 3, wherein the representing includes
geometrically constructing the line in the form of a straight line on the basis of at least one of:
parallelism conditions;
symmetry conditions;
collinearity conditions; and
perpendicularity conditions.

18. The construction method according to claim 3, wherein the representing includes
geometrically constructing the line in the form of a straight line on the basis of at least one of:
parallelism conditions;
symmetry conditions;
collinearity conditions; and
perpendicularity conditions.

19. The construction method according to claim 4, wherein the representing includes
geometrically constructing the line in the form of a straight line on the basis of at least one of:
parallelism conditions;
symmetry conditions;
collinearity conditions; and
perpendicularity conditions.

20. The construction method according to claim 12, wherein the representing includes
geometrically constructing the line in the form of a straight line on the basis of at least one of:
parallelism conditions;
symmetry conditions;
collinearity conditions; and
perpendicularity conditions.

21. The construction method according to claim 13, wherein the representing includes
geometrically constructing the line in the form of a straight line on the basis of at least one of:
parallelism conditions;
symmetry conditions;
collinearity conditions; and
perpendicularity conditions.
